(19) United States
(12) Patent Application Publication
(10) Pub. No.: US 2011/0262071 A1
(43) Pub. Date: Oct. 27, 2011

(54) BRANCHED OPTICAL WAVEGUIDE, OPTICAL WAVEGUIDE SUBSTRATE AND OPTICAL MODULATOR

(75) Inventors: Osamu Mitomi, Machida-City (JP); Kenji Aoki, Nagoya-city (JP); Yuji Hori, Nagoya-City (JP); Jungo Kondo, Nishikamo-Gun (JP); Yasunori Iwasaki, Kitanagoya-City (JP)

(73) Assignee: NGK Insulators, Ltd., Nagoya-City (JP)

(21) Appl. No.: 13/178,964

(22) Filed: Jul. 8, 2011

Related U.S. Application Data
(63) Continuation of application No. PCT/JP2010/050581, filed on Jan. 13, 2010.

(30) Foreign Application Priority Data
Jan. 16, 2009 (JP) 2009-007550

(51) Int. Cl. G02F 1/035; G02B 6/125

(52) U.S. Cl. 385/2; 385/14

(57) ABSTRACT

An optical waveguide is formed on a ferroelectric substrate having a thickness of 20 μm or less by diffusion of a dopant or ion exchange. The optical waveguide has a non-branched section 2a operating on single mode and a pair of branched sections branched from the non-branched section 2a. Each of the branched sections has a connecting part 7 extending from a branching end 10 and a multi mode propagating part 8 continuously formed from the connecting part 7. The multi mode propagating part 8 has a width “m” larger than a width “t” of the non-branched section. A width “p” of the connecting part increases from the non-branched section 2a toward the multi mode propagating part 8.

### TECHNICAL FIELD

The present invention relates to an optical waveguide device such as an optical modulator.

### BACKGROUND ART

In the case that a branched optical waveguide of titanium diffusion optical waveguide is formed on an LiNbO₃ substrate, in prior arts, as shown in FIG. 7(a) for example, a pair of branched sections 8 are extended straightforwardly from a branching point 10 of a non-branched section 2a (2b) in an inclined manner. The width “m” of the non-branched section 2a (2b) is same as a width “m” of the branched section 8. It is thereby formed a Y-character-shaped pattern as a whole. Further, as shown in FIG. 7(b), an arc-like curved pattern is applied for reducing the length required for the branching.

These methods, however, have a defect of excessive loss in a connecting part 3 (4). Particularly in the case that an LiNbO₃ substrate forming a titanium diffusion waveguide is as thin as 20 μm or smaller, the excessive loss is considerable.

Further in the case of a Y-character-shaped branched optical waveguide described in Japanese Patent Publication No. H09-211244A, between one optical waveguide of single mode and two branched single mode optical waveguides, a wider multi mode propagation part is provided. That is, light propagates in the one optical waveguide in single mode, and then spreads in the wider multi mode propagation part to provide optical power density having two robes. It is tried to reduce the branching loss, by providing the two single mode optical waveguides at positions corresponding to the respective two robes (0036). Therefore, the excessive loss in the arc-like curved part of the single mode optical waveguide after the branching is large.

According to the following documents, in a diffusion type optical waveguide formed on a thick optical waveguide substrate, it is tried to provide a wedge-like low refractive index part deep inside of the branching part, for reducing the branching loss.

1988'th Autumn National Conference by The Institute of Electronics, Information and Communication Engineers, C-201, “Consideration on Low-Loss Y-branch Waveguide Using MgO-diffusion” by Tsutomu KITOH and Kenji KAWANO

1986'th National Conference by The Institute of Electronics, Information and Communication Engineers, 882, “Branching characteristics of antenna coupled Y junctions which low index regions are displaced by claddings” by Osamu HANAIZUMI and Shojiro KAWAKAMI

1985'th National Conference by The Institute of Electronics, Information and Communication Engineers, 962, “Fabrication of antenna-coupled Y-junction by K-doped waveguide” by Osamu HANAIZUMI, Makoto MINAKATA and Shojiro KAWAKAMI

On the other hand, for providing high-speed operating optical modulator, it is studied a structure of applying a thin plate (thickness of 20 μm or smaller) of an electro-optical substrate for the velocity matching. In the case that the modulator is applied as an optical intensity modulator, its optical waveguide is constituted as a Mach-Zehnder type optical waveguide having a Y-character-shaped branched waveguide. In the case that such thin substrate of an electro-optic material, it is desirable to widen strips of dopants such as titanium before its thermal diffusion in the branched optical waveguide. It is thereby possible to realize the confinement of light, to lower the loss even when electrode gaps are made smaller in titanium interacting parts, and to reduce the radiation excessive loss in the arc like curved part of the optical waveguide (Japanese Patent Publication No. 2007-133135A). On the other hand, its input or output part (non-branched section) formed by a single waveguide is preferably a single mode waveguide, for realizing a good extinction ratio of the optical modulator.

### DISCLOSURE OF THE INVENTION

That is, the present inventors have tried, in a thin plate type optical waveguide device, to make its branched waveguides operating as a multi mode waveguide, for reducing the radiation excessive loss in the arc like curved part of the optical waveguide. In the case that the diffusion type optical waveguide is used, the width of the strip of dopant after the branching is larger than that before the branching, before the thermal diffusion.

In such type of reducing the excessive loss in the curved part of the multi mode optical waveguide by providing the waveguide after the branching, it is proved that the dependency of the extinction ratio and of the branching loss on wavelength are found. The reason is considered to be that light is propagated in the non-branched section in single mode and in each branched section in multi mode. In optical communication systems using WDM system, if the extinction ratio and branching loss of the optical waveguide device is changed depending on wavelength, the characteristic is also changed among channels, which is problematic.

An object of the present invention is, in a Y-character-shaped optical waveguide having a non-branched section of single mode propagation and branched sections of multi mode propagation, to reduce the dependency of branching loss on wavelength.

The present invention provides a diffusion type optical waveguide formed on a ferroelectric substrate having a thickness of 20 μm or smaller. The optical waveguide has a non-branched section for propagating light in single mode and a pair of branched sections branched from the non-branched section. Each of the branched sections has a connecting part extending from a branching end and a multi mode propagating part continuously formed from the connecting part. The multi mode propagating part has a width larger than that of the non-branched section. A width of the connecting part increases from the non-branched section toward the multi mode propagating part.

Further, the present invention provides an optical waveguide substrate having a ferroelectric substrate with a thickness of 20 μm or smaller and the optical waveguide provided in the ferroelectric substrate.

Further, the present invention provides an optical modulator having the optical waveguide substrate, and signal and ground electrodes for modulating light propagating in the optical waveguide.

Further, the present invention provides a diffusion type optical waveguide formed on a ferroelectric substrate having a thickness of 20 μm or smaller. The optical waveguide has a non-branched section for propagating light in single mode and a pair of branched sections branched from the non-branched section. Each of the branched sections has a connecting part extending from a branching end and a multi mode propagating part continuously formed from the connecting part. The multi mode propagating part has a spot size larger than that of the non-branched section. A spot size of the connecting part increases from the non-branched section toward the multi mode propagating part.

The present inventors have reached the idea of, in an optical waveguide having a narrower non-branched section operating on single mode propagation and a wider branched section operating on multi mode in a thin plate, providing a connecting part extending from an end of the non-branched section and of increasing the width of the connecting part from the non-branched section toward the multi mode propagating section. It is found that the dependency of the branching loss on wavelength can be considerably reduced, so that the present invention is made.

Besides, according to the three scientific documents described in the “Background arts” section, the width of a multi mode optical waveguide after the branching is constant and the waveguide does not include the connecting part of the present invention.

Further, according to the Y-character shaped branched optical waveguide disclosed in Japanese Patent Publication No. H09-211244A, a wider multi mode propagation part is provided between the one single mode optical waveguide and the two single mode optical waveguides after the branching. Light is propagated in the one single mode optical waveguide and then widened in the wider multi mode propagation part to split into two robes in optical power distribution. It was tried to reduce the branching loss by providing two single mode optical waveguides at the respective positions corresponding with the two robes (0036). However, the width of each of the two optical waveguides after the branching is constant and the connecting part of the present invention is not provided. Therefore, the excessive loss is large in the curved part of the single mode optical waveguide after the branching. Further, since the waveguide after the branching is constituted as the narrow single mode optical waveguide, it is considered that the dependency of insertion loss on wavelength is small and the problems to be solved by the invention are not induced.

### BRIEF DESCRIPTION OF THE DRAWINGS

FIG. 1 is a plan view showing a Mach-Zehnder type optical waveguide of the present invention.

FIG. 2 is an enlarged plan view showing an essential part of an optical waveguide according to an embodiment of the present invention.

FIG. 3 is an enlarged plan view showing an essential part of an optical waveguide according to another embodiment of the present invention.

FIG. 4 is an enlarged plan view showing an essential part of an optical waveguide according to still another embodiment of the present invention.

FIG. 5 is an enlarged plan view showing an essential part of an optical waveguide according to a comparative example.

FIG. 6 is an enlarged plan view showing an essential part of an optical waveguide according to a comparative example.

FIG. 7 (a) and (b) are enlarged plan views showing essential parts of an optical waveguide according to a comparative example.

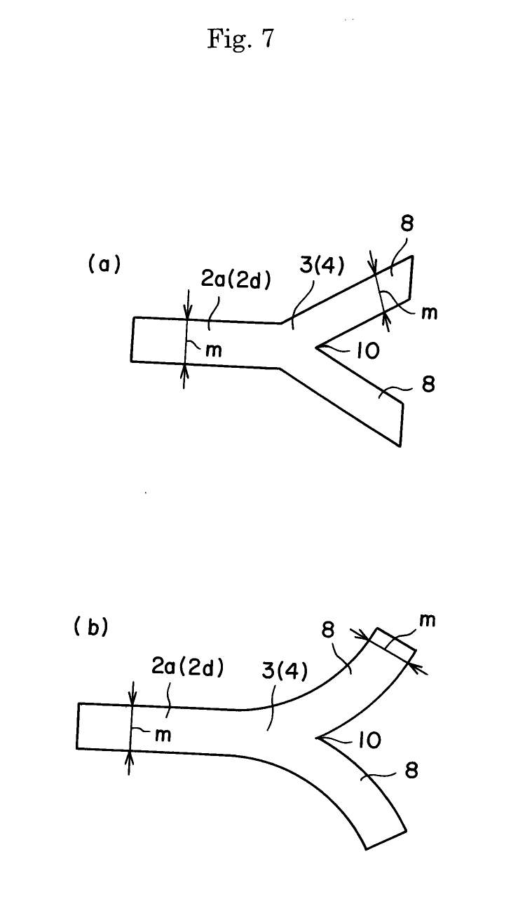

### EMBODIMENTS OF THE INVENTION

Although the optical waveguide device of the present invention may most preferably be an optical intensity modulator or optical phase modulator, it includes other optical waveguide devices such as a harmonic generating device, an optical switch, an optical signal processor and a censor device.

The present invention may be applied to so called CoPlanar waveguide type electrode configuration. According to the Coplanar type, a single line signal electrode is provided between a pair of ground electrodes. Further, the present invention may be applied to a traveling type optical modulator of independent modulation type. Further, the optical modulator may be an intensity or phase modulator. Phase modulation system in the case of using phase modulation parts is not particularly limited, and includes various modulation systems such as DQPSK (Differential Quadrature Phase Shift Keying), SSB (Single Side Band Amplitude Modulation) and DPSK (Differential Phase Shift Keying). Each of the modulation systems itself is known.

The present invention will be described in detail referring to the attached drawings.

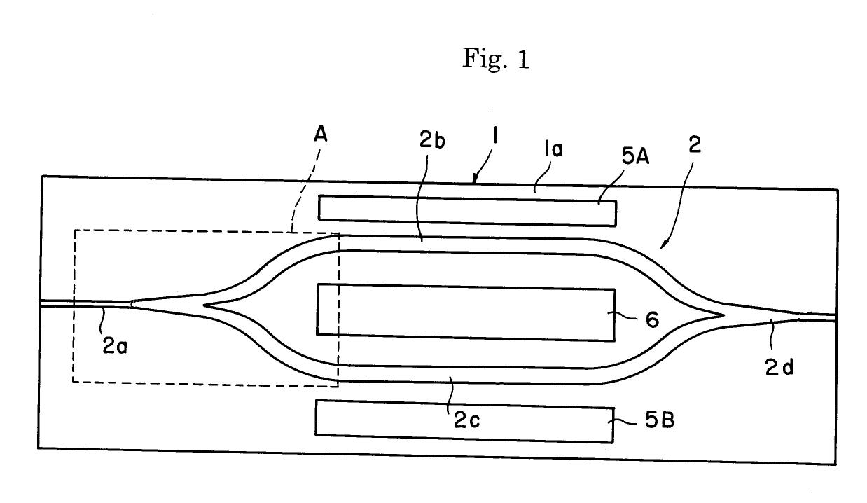

FIG. 1 is a plan view schematically showing an optical modulator according to an embodiment of the present invention.

According to the embodiment, an optical waveguide 2 is formed on the side of a surface 1a of a substrate 1. The optical waveguide 2 includes an input section 2a, branched sections 2b, 2c and an emitting section 2d, so as to form an optical waveguide of Mach-Zehnder type.

That is, light is made incident into the input section 2a of the optical waveguide, then divided into two waveguides, and propagates in the respective modulation regions through respective curved parts. In each of the modulation parts, a predetermined voltage is applied on the light by means of each of signal electrodes 5A, 5B and a ground electrode 6 for the modulation. Then, the light beams are combined after propagating the curved parts and then emitted from the emitting part 2d. The signal voltage is to be applied on each of the branched sections 2b and 2c substantially in horizontal direction in the modulation region.

The thickness of the optical waveguide substrate 1 is 20 μm or smaller, and more preferably be 10 μm or smaller. It is thus preferred to adhere a separate supporting body to a bottom face of the optical waveguide substrate through an adhesive layer. The lower limit of the thickness of the optical waveguide substrate 1 is not particularly limited, and may preferably be 1 μm or more on the viewpoint of mechanical strength.

The diffusion type optical waveguide according to the present invention can be obtained by diffusing dopants through openings of a patterned covering on the optical waveguide substrate to form high refractive index regions. Further, the width of the optical waveguide means a width of the openings of the covering used for the diffusion of the dopants into the substrate.

Specifically, the followings are preferred.

### (1) Diffusion Type Optical Waveguide Formed by Metal Diffusion

In this case, a photo resist is formed on a substrate of an electro-optic material by photolithography, and metal is deposited thereon through openings of the photo resist. The photo resist functions as the covering. The photo resist may be a so-called positive resist or negative resist. Deposited films of the dopants each having a shape of a strip are thereby formed on a surface of the substrate. Then, the dopant is thermally diffused to form the optical waveguide. In this case, it is generally known to skilled artisans that the width of the optical waveguide means the width of the opening of the photo resist. The dopant includes titanium and zinc.

### (2) Proton Exchange Waveguide

A mask is provided on the substrate of an electro-optic material by means of photo lithography so as to form a metal mask with patterned openings. The metal mask functions as the covering. The substrate is then immersed in a proton source such as benzoic acid. The openings of the metal mask are exposed to the proton source such as benzoic acid and Li ions and H⁺ ions (proton) in benzoic acid are exchanged with each other so that protons are doped and the refractive index is increased to form the optical waveguide. Since the exchange of proton takes place only in the openings of the mask, the width of a region of the proton exchange matches with the width of the openings of the metal mask. The width of the proton exchange optical waveguide is the width of the openings of the metal mask.

Further, as the width of the openings of the covering is larger, the spot size of the thus formed diffusion type optical waveguide generally becomes larger. The spot size can be measured using “Near Field pattern (NFP) Measurement System” supplied by Hamamatsu Photonics K.K.

Further, in the case of the metal-diffusion type optical waveguide, a small protrusion is formed on the thus produced optical waveguide. Generally, as the width of the covering is larger, the width of the protrusion of the wave guide tends to be larger. The width of the protrusion can be measured by a laser microscope.

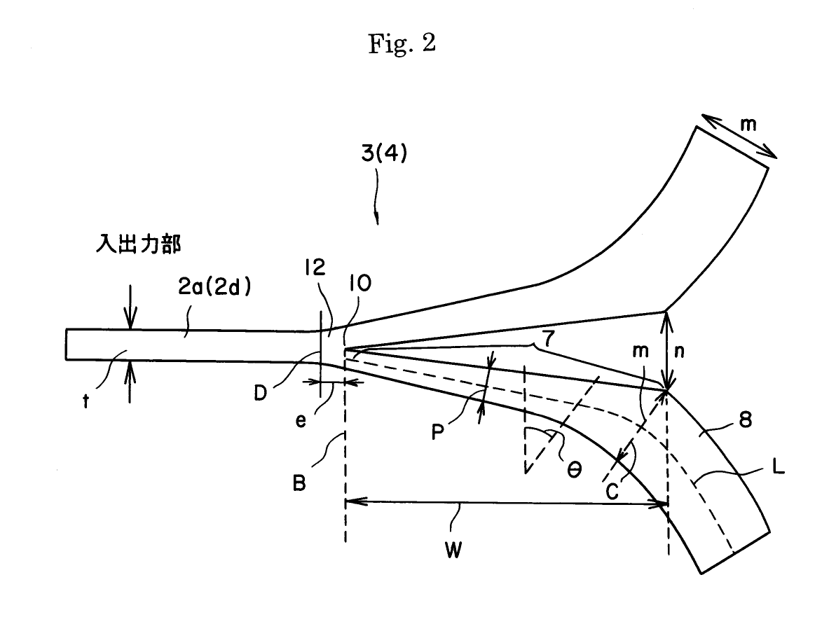

FIG. 2 is an enlarged view showing planar pattern of a connecting part “A” of an optical waveguide. The present invention may be applied to each of the input and emitting parts. On the side of the input part, light is propagated in the non-branched section (input section) 2a and then divided. On the side of the emitting section, light is propagated through the two branched sections, combined and then made incident into the non-branched section (emitting section) 2d.

According to the present invention, the width “t” of the non-branched section is made smaller to realize single mode propagation. On the viewpoint, “t” may preferably be 10 μm or smaller and more preferably be 6 μm or smaller. Further, “t” may preferably be 0.5 μm or larger, on the viewpoint of reducing propagation loss.

The width “m” of the multi mode propagation part 8 is made larger to realize multi mode propagation. On the viewpoint, “m” may preferably be 2 μm or larger and more preferably be 5 μm or larger. Further, “m” may preferably be 15 μm or smaller, on the viewpoint of reducing absorption loss accompanied with a high dopant concentration. Further, the width of the multi mode propagation part may preferably be constant.

According to the present invention, the width “m” of the multi mode propagating section 8 is larger than the width “t” of the non-branched section. m/t may preferably be 1.2 or larger, more preferably be 2 or larger and most preferably be 4 or larger.

According to the present invention, a connection part 7 is provided from a branching point 10 of the non-branched sections 2a, 2d toward each multi mode propagating part. The connection part 7 is characterized in that its width “p” is increased from each of the non-branched sections 2a, 2d toward each multi mode propagation part 8. It is found that the dependency of the branching loss on wavelength can be reduced by providing such connecting part between the multi mode propagation part and branching end. Further, in the case of an optical modulator, it is possible to reduce the dependency of extinction ratio on wavelength.

Generally, the maximum value of the width “p” is “m” and minimum value is “t”. Between them, the width “p” of the connecting part is preferably monotonously increased from the non-branched section toward the multi mode propagation part over the whole of the connecting part. However, one or plural region(s) where the width “p” is constant may be provided between the non-branched section and multi mode propagation part. It is preferred that there is no region whose width “p” is decreased viewed from the non-branched section toward multi mode propagating part.

The branching end means the position where branching of the core of the optical waveguide starts at. The branching end corresponds to a branching point 10 in the example of FIG. 2. Although the width “t” of the non-branched section is constant in the example of FIG. 2, a small enlarged part 12 is provided in the vicinity of the end 10. The enlarged part 12 is extended from a starting point “D” to an ending point “B”. The length “e” of the enlarged part is not particularly limited. The width of the non-branched section means the width “t” of the part for single mode propagation excluding the enlarged part, according to the present invention.

Further, according to the present example, the connecting part 7 is formed from a starting point “B” to an ending point “C”. “C” means a position where the width “p” reaches the width “m”. The width “p” is monotonously increased at a predetermined rate in the vicinity of the starting point “B”. The width “p” is further increased to reach “m”. At such position, the multi mode propagating part 8 having a constant width starts.

Besides, each of the width “t” of the non-branched section, width “p” of the connecting part and width “m” of the multi mode propagating part means lengths of line segments, respectively, provided that each of the line segments is drawn in the direction perpendicular to the central line “L” of the corresponding opening and that the length of the line segment is measured between two crossing points of the line segment and the edge of the opening.

Although the length “W” of the connecting part 7 is not particularly limited, it may preferably be 300 μm or longer, more preferably be 600 μm or longer and most preferably be 800 μm or longer, on the viewpoint of the present invention. Further, on the viewpoint of reducing the whole length of the optical waveguide device, it may preferably be 3000 μm or shorter and more preferably be 2000 μm or shorter.

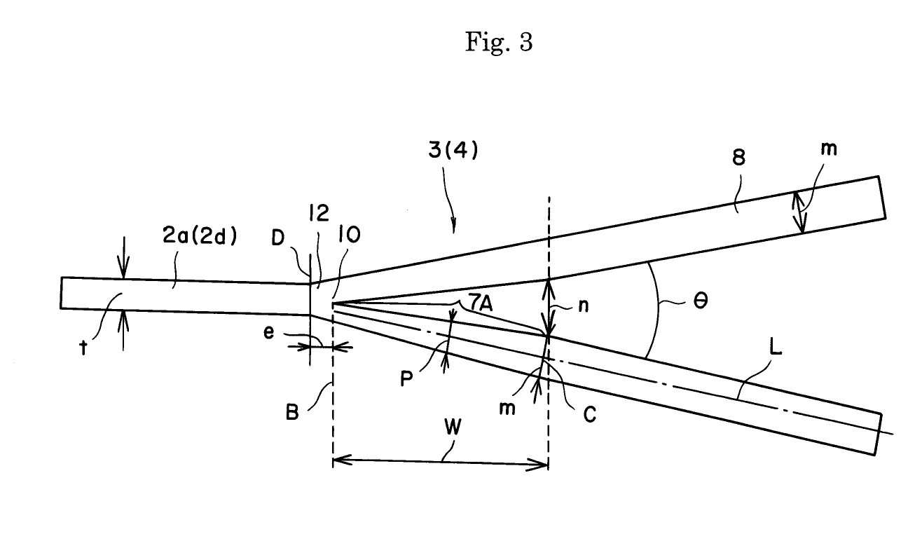

According to the example of FIG. 3, a connecting part 7A is provided from the branching end 10 of the non-branched sections 2a, 2d toward each multi mode propagation part. The width “p” of the connecting part 7A is increased from each of the non-branched sections 2a, 2d toward each multi mode propagation part 8. According to the present example, the width “p” of the connecting part 7A is monotonously increased according to a linear function from the non-branched section toward the multi mode propagating part in the whole of the connecting part 7A. Further, although the width “t” of the non-branched part is constant, a small enlarged part 12 is provided in the vicinity of the end 10. The enlarged part 12 is extended from the starting point “D” to the ending point “B”.

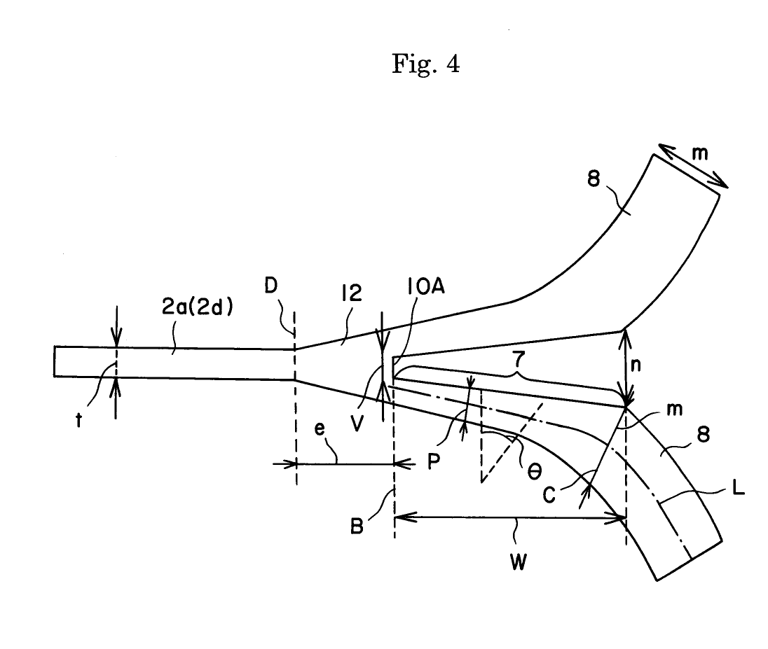

The pattern of FIG. 4 is substantially same as that of FIG. 2, except that the shape of the branching end 10A is modified. That is, the width “v” of the end 10A is wider so that the width and length of the enlarged part 12 are made larger.

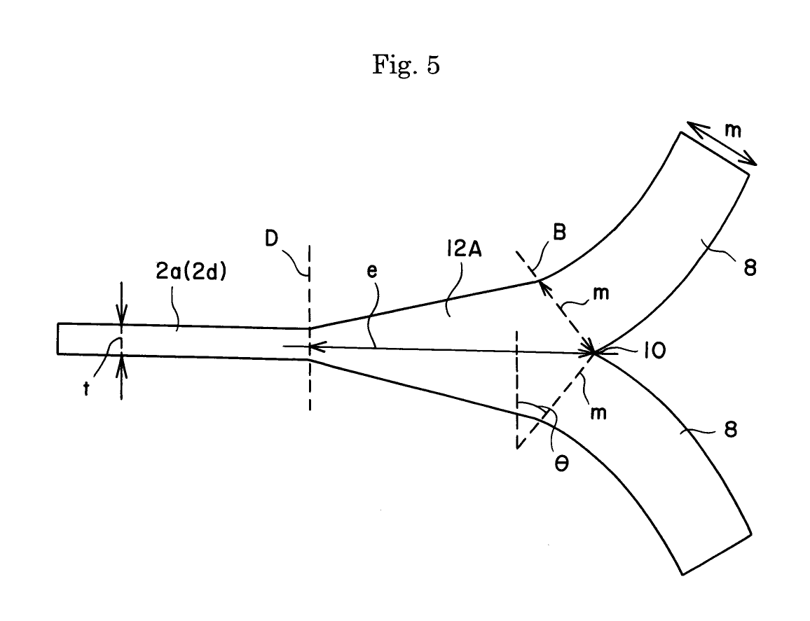

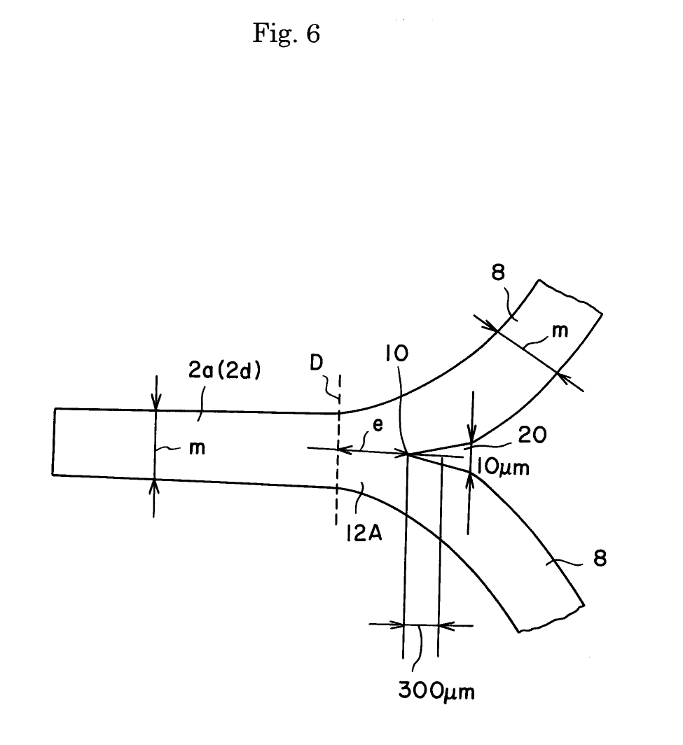

FIGS. 5 and 6 are related to a comparative example. According to the example of FIG. 5, each multi mode propagating part 8 is extended from each branching end 10 of each of the non-branched sections 2a, 2d. The width “m” of the multi mode propagating part 8 is constant.

Here, according to the example of FIG. 5, it is not provided the connecting part 7 defined in the present invention. Instead, an enlarged part 12A is provided on the side of the end 10 of the non-branched section 2a (2d) and the length “e” of the enlarged part 12A is larger.

Further according to the example, the enlarged part 12A, whose width is monotonously increased, is provided between the non-branched section with a smaller width and the multi mode propagating part with a larger width. When the present inventors tried to produce the optical waveguide of such design, however, it is proved that the dependency of the branching loss on wavelength is not improved and the effects of the present invention are not attained. The reason is not clear to show the unpredictable nature of the present invention.

Further according to the example of FIG. 6, the enlarged part 12A is provided on the side of the branching end 10 of the non-branched section 2a (2d) and the length “e” of the enlarged part is larger. Then, a cutting 20 having a ridge shape of a triangle on the side of the branching end 10.

Materials forming the optical waveguide substrate and supporting body may be a ferroelectric electro-optic material and may preferably be a single crystal. Although such crystal is not particularly limited as far as it is capable of modulating light, it includes lithium niobate, lithium tantalate, lithium niobate-lithium tantalate solid solution, potassium lithium niobate, KTP, quartz or the like.

Materials for the supporting body may be a glass such as quartz glass in addition to the above listed ferroelectric electro-optic materials.

Although there is no specific restriction on the adhesive as far as the aforementioned conditions are satisfied, epoxy adhesives, thermosetting adhesives, ultraviolet curing adhesives, Aron Ceramics C (name of a product from Toagosei Co., Ltd.) (coefficient of thermal expansion: 13×10⁻⁶/K) having the coefficient of thermal expansion near that of an electro-optic material such as lithium niobate are examples thereof.

According to above examples, the electrodes are provided on the surface of the substrate, and the electrodes may be formed directly on the surface of the substrate or formed on a low dielectric layer or a buffer layer. The low dielectric layer may be made of known materials such as silicon oxide, magnesium fluoride, silicon nitride and alumina. The low dielectric layer referred to here means a layer made of a material having a dielectric constant lower than that of the material forming the substrate.

Materials and methods of forming a photo mask for photolithography used for forming the optical waveguide are not particularly limited, and include conventional ones used for photolithography. The photo mask may preferably be a photo mask made of a glass (quartz) and chromium thereon. Further, the metal mask for forming the ion-exchange type optical waveguide includes chromium, titanium and aluminum, for example.

### EXAMPLES

### Example 1

The optical waveguide substrate was produced according to the example described referring to FIGS. 1 and 2.

Specifically, the diffusion type optical waveguide was formed on an X-cut LiNbO3 substrate with a thickness of 6 micron by titanium diffusion. The width “m” of the openings of the resist (width of the strip of titanium) for the multi mode propagating part was 6 μm, and the width “t” of the openings of the resist for the non-branched section was 2 μm. θ was made 0.5°. The length “e” of the enlarged part 12 was made 10 μm, and the length “W” of the connecting part 7 was made 1005 μm. “n” was made 10 μm. The width “p” of the connecting part 7 was monotonously increased from 1 μm to 6 μm. The thickness of the titanium film was made 800 angstrom and the radius of curvature of an arc formed by the branched part was made 20 mm. The diffusion of titanium was carried out at 1050° C.

The branching loss at the Y-character branching was measured at a wavelength of 1.55 micron to prove to be 0.24 dB. Further, the branching loss in C-band (wavelength of 1.53 to 1.56 micron) was measured at plural wavelengths using a variable wavelength light source to prove that the dependency on wavelength was low and 0.23 dB to 0.47 dB. Further, the two Y-character-shaped branched waveguides were used to constitute a MZ optical waveguide and an optical modulator, so that the extinction ratio in C-band was proved to be more than 25 dB.

The optical waveguide substrate was produced according to the example described referring to FIGS. 1 and 2.

Specifically, the diffusion type optical waveguide was formed on an X-cut LiNbO3 substrate with a thickness of 6 micron by titanium diffusion. The width “m” of the multi mode propagating part was 6 μm, and the width “t” of the non-branched section was 2 μm. θ was made 0.5°. The length “e” of the enlarged part 12 was made 10 μm, and the lengths “W” of the connecting parts 7 were made 300, 450 or 600 μm. “n” was made 10 μm. The width “p” of the connecting part 7 was monotonously increased from 1 μm to 6 μm. The thickness of the titanium film was made 800 angstrom and the radius of curvature of an arc formed by the branched part was made 20 mm. The diffusion of titanium was carried out at 1050° C.

The branching loss at the Y-character branching was measured at a wavelength of 1.55 micron to obtain the following results. It was 0.24 dB. Further, the branching loss in C-band (wavelength of 1.53 to 1.56 micron) was measured at plural wavelengths using a variable wavelength light source to prove that the dependency on wavelength was low and 0.23 dB to 0.47 dB. Further, the two Y-character-shaped branched waveguides were used to constitute a MZ optical waveguide and an optical modulator, so that the extinction ratio in C-band was proved to be more than 25 dB.

TABLE 1

| W | Branching loss at C-band | Extinction ratio |
|---|---|---|
| 300 micron | 0.30 to 0.90 dB | 23 dB |
| 450 micron | 0.24 to 0.65 dB | More than 25 dB |
| 600 micron | 0.23 to 0.48 dB | More than 25 dB |

### Example 2

The optical waveguide substrate was produced according to the example described referring to FIGS. 1 and 3.

Specifically, the diffusion type optical waveguide was formed on an X-cut LiNbO3 substrate with a thickness of 6 micron by titanium diffusion. The width “m” of strip for the multi mode propagating part was 6 μm, and the width “t” of the strip for the non-branched section was 2 μm. The whole branching angle θ was made 1°. “e” was made 10 μm, and the length “W” of the connecting part 7 was made 900 μm. “n” was made 6 μm. The width “p” of the connecting part 7 was monotonously increased from 1 μm to 6 μm. The thickness of the titanium film was made 800 angstrom and the radius of curvature of an arc formed by the branched part was made 20 mm. The diffusion of titanium was carried out at 1050° C.

The branching loss at the Y-character branching was measured at a wavelength of 1.55 micron to prove to be 0.15 dB. Further, the branching loss in C-band was measured to prove to be 0.13 dB to 0.44 dB. Further, the two Y-character-shaped branched waveguides were used to constitute a MZ optical waveguide and an optical modulator, so that the extinction ratio in C-band was proved to be more than 25 dB.

### Example 3

The optical waveguide substrate was produced according to the example described referring to FIGS. 1 and 4.

Specifically, the diffusion type optical waveguide was formed on an X-cut LiNbO3 substrate with a thickness of 6 micron by titanium diffusion. The width “m” of the width of the strip of titanium for the multi mode propagating part was 6 μm, and the width “t” of the titanium strip for the non-branched section was 2 μm. θ was made 0.5°. The length “e” of the enlarged part 12 was made 110 μm, the width “v” of the branching end 10A was made 1 μm, and the length “W” of the connecting part 7 was made 800 μm. “n” was made 6 μm. The width “p” of the connecting part 7 was monotonously increased from 1 μm to 6 μm. The thickness of the titanium film was made 800 angstrom and the radius of curvature of an arc formed by the branched part was made 20 mm. The diffusion of titanium was carried out at 1050° C.

The branching loss at the Y-character branching was measured at a wavelength of 1.55 micron to prove to be 0.25 dB. Further, the branching loss in C-band (wavelength of 1.53 to 1.56 micron) was measured at plural wavelengths using a variable wavelength light source to prove that the dependency on wavelength was low and 0.24 dB to 0.49 dB. Further, the two Y-character-shaped branched waveguides were used to constitute a MZ optical waveguide and an optical modulator, so that the extinction ratio in C-band was proved to be more than 25 dB.

### Comparative Example 1

The optical waveguide substrate was produced according to the example described referring to FIGS. 1 and 5.

Specifically, the diffusion type optical waveguide was formed on an X-cut LiNbO3 substrate with a thickness of 6 micron by titanium diffusion. The width “m” of width of the strip of titanium for the multi mode propagating part was 6 μm, and the width “t” of the titanium strip for the non-branched section was 2 μm. θ was made 0.5°. The radius of curvature was made 20 mm. The length “e” of the enlarged part 12 was made 910 μm. The thickness of the titanium film was made 800 angstrom. The radius of curvature of an arc of the branched part was made 20 mm. The diffusion of titanium was carried out at 1050° C.

The branching loss at the Y-character branching was measured at a wavelength of 1.55 micron to prove to be 0.52 dB. Further, the branching loss in C-band was measured to prove that the dependency was considerable and 0.41 dB to 1.7 dB. Further, the two Y-character-shaped branched waveguides were used to constitute a MZ optical waveguide and an optical modulator, so that the extinction ratio in C-band was proved to be considerable and 15 to 21 dB.

### Comparative Example 2

The optical waveguide substrate was produced according to the example described referring to FIGS. 1 and 5.

Specifically, the diffusion type optical waveguide was formed on an X-cut LiNbO3 substrate with a thickness of 500 micron by titanium diffusion. The width “m” of the width of the strip of titanium for the multi mode propagating part was 8 μm, and the width “t” of the strip of the dopant for the non-branched section was 5 μm. θ was made 0.5°. The radius of curvature of the arc was made 20 mm. The length “e” of the enlarged part 12 was made 910 nm. The thickness of the titanium film was made 800 angstrom and the radius of curvature of an arc formed by the branched part was made 20 mm. The diffusion of titanium was carried out at 1050° C.

The branching loss at the Y-character branching was measured at a wavelength of 1.55 micron to prove to be 0.31 dB. Further, the branching loss in C-band was measured to prove that the dependency was low and 0.25 dB to 0.43 dB. Further, the two Y-character-shaped branched waveguides were used to constitute a MZ optical waveguide and an optical modulator, so that the extinction ratio in C-band was proved to be more than 25 dB.

Though the specific embodiments of the present invention have been described, the present invention is not limited to these specific embodiments, and may be changed and modified in various ways without departing from the scope of claims.

1. A diffusion type optical waveguide formed on a ferroelectric substrate having a thickness of 20 μm or smaller, said optical waveguide comprising a non-branched section operating on single mode and a pair of branched sections branched from said non-branched section,
wherein each of said branched sections comprises a connecting part extending from a branching end and a multi mode propagating part continuously formed from said connecting part,
wherein said multi mode propagating part has a width larger than that of said non-branched section, and
wherein a width of said connecting part increases from said non-branched section toward said multi mode propagating part.

2. The optical waveguide of claim 1, wherein the width of said connecting part is monotonically increased from said non-branched section toward said multi mode propagating part.

3. The optical waveguide of claim 1, wherein the width of said multi mode propagating part is constant.

4. The optical waveguide of claim 1, wherein said optical waveguide comprises a Mach-Zehnder type optical waveguide.

5. An optical waveguide substrate comprising a ferroelectric substrate having a thickness of 20 μm or less, and said optical waveguide of claim 1 provided on said ferroelectric substrate.

6. An optical modulator comprising said optical waveguide substrate of claim 5, and signal and ground electrodes for modulating light propagating in said optical waveguide.

7. A diffusion type optical waveguide formed on a ferroelectric substrate having a thickness of 20 μm or smaller, said optical waveguide comprising a non-branched section operating on single mode and a pair of branched sections branched from said non-branched section,
wherein each of said branched sections comprises a connecting part extending from a branching end and a multi mode propagating part continuously formed from said connecting part,
wherein said multi mode propagating part has a spot size larger than that of said non-branched section, and
wherein a spot size of said connecting part increases from said non-branched section toward said multi mode propagating part.
